(19) United States
(12) Patent Application Publication
(10) Pub. No.: US 2021/0304783 A1
(43) Pub. Date: Sep. 30, 2021

(54) VOICE CONVERSION AND VERIFICATION

(71) Applicant: International Business Machines Corporation, Armonk, NY (US)

(72) Inventors: ZVI KONS, YOQNEAM ILIT (IL); VYACHESLAV SHECHTMAN, HAIFA (IL)

(21) Appl. No.: 16/835,434

(22) Filed: Mar. 31, 2020

(51) Int. Cl. G10L 21/0272; G10L 13/033; G10L 25/51; G10L 19/018

(52) U.S. Cl. CPC G10L 21/0272; G10L 19/018; G10L 25/51; G10L 13/033

(57) ABSTRACT

Method, system and computer program product, the method comprising: receiving a first audio, wherein the first audio is a conversion of an audio by a first source to a second source, wherein the first audio having embedded therein first information characterizing the first source of the audio; extracting from the first audio the first information of the first source embedded within the first audio; obtaining second information characterizing a third source; comparing the first information to the second information to obtain comparison results; and subject to the comparison results indicating that the first source is the same as the third source, initiating an action.

### TECHNICAL FIELD

The present disclosure relates to voice conversion in general, and to a method and apparatus for verifying the source of a converted speech, in particular.

### BACKGROUND

With the advancements of audio analysis, significant efforts have been directed to identifying speakers in given audio signals, in particular aiming at some important tasks, including speaker verification.

Speaker verification, also referred to as speaker authentication, relates to determining, given an audio signal in which a speaker is speaking, and characteristics of the alleged speaker, whether (or what is the probability that) the alleged speaker is indeed the person speaking in the audio signal. The characteristics may refer to a personal voice signature comprising vocal or acoustic attributes. If the distance, as calculated in accordance with an adequate metrics, between the characteristics of the alleged speaker and the characteristics of the speaker in the audio signal is below a predetermined threshold, it may be assumed that the speaker of the audio signal is indeed the alleged speaker.

Voice conversion, used as voice synthesis or speech synthesis to change one or more attributes or aspects of a speech signal, while preserving linguistic information, such that the generated output is perceived as the same content as the original being uttered by a target speaker rather than the actual speaker.

Multiple voice conversion systems of various qualities are currently available. In addition to legitimate uses, such as dubbing audio or video, or other entertainment purposes, such systems might be used for malicious purposes, such as deceiving financial or other organizations by pretending to be another person.

### BRIEF SUMMARY

One exemplary embodiment of the disclosed subject matter is a computer-implemented method comprising: receiving a first audio, wherein the first audio is a conversion of an audio by a first source to a second source, wherein the first audio having embedded therein first information characterizing the first source of the audio; extracting from the first audio the first information of the first source embedded within the first audio; obtaining second information characterizing a third source; comparing the first information to the second information to obtain comparison results; and subject to the comparison results indicating that the first source is the same as the third source, initiating an action.

Another exemplary embodiment of the disclosed subject matter is a computer-implemented method comprising: receiving a first audio, wherein the first audio is a conversion of an audio by a first source to a second source, wherein the first audio having embedded therein first information characterizing the first source of the audio; extracting from the first audio the first information of the first source based on the information embedded within the first audio; and synthesizing, based on the first information, a second audio comprising speech in the likeness of the first source.

Yet another exemplary embodiment of the disclosed subject matter is a computer program product comprising a non-transitory computer readable medium retaining program instructions, which instructions when read by a processor, cause the processor to perform: receiving a first audio, wherein the first audio is a conversion of an audio by a first source to a second source, wherein the first audio having embedded therein first information characterizing the first source of the audio; extracting from the first audio the first information of the first source embedded within the first audio; obtaining second information characterizing a third source; comparing the first information to the second information to obtain comparison results; and subject to the comparison results indicating that the first source is the same as the third source, initiating an action.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method for verifying the identity of a speaker in a converted audio signal, in accordance with some exemplary embodiments of the disclosed subject matter;

FIG. 2 shows a flowchart diagram of a method for authentication a speaker in an audio signal, in accordance with some exemplary embodiments of the disclosed subject matter; and

FIG. 3 shows a block diagram of a system configured for verifying the identity or the authenticity of a speaker in an audio signal, in accordance with some exemplary embodiments of the disclosed subject matter.

### DETAILED DESCRIPTION

The quality of speech synthesis has improved dramatically over the recent years, and currently there exist systems which can generate speech that is almost undistinguishable from human speech. Moreover, it is possible to learn the characteristics of the voice of a target speaker, and change the attributes or aspects of a speech signal while preserving linguistic information, to obtain speech that sounds close enough to the target speaker, to deceive human listeners as well as voice verification systems.

In addition to legitimate uses, such as dubbing movies, entertainment, or the like, voice conversion may be attractive for a variety of malicious purposes, such as pretending to be another person when calling a bank or another institute, for committing fraud.

Thus, one technical problem is a need to verify that an audio signal is indeed spoken by an alleged specific person. For example, a person may call a bank and identify as a customer of the bank, using a mechanism such as password, personal details, or the like. Then, it may be required to verify that the person that speaks on the interaction is indeed the customer, and not another person who obtained the customer's personal details, and converted his or her voice to sound like the voice of the customer.

Another technical problem may relate to verifying that an audio signal is authentic, i.e., that it can be attributed to the person that uttered speech in the audio signal, and that no voice conversion has been attempted when creating the audio signal.

Yet another technical problem relates to limiting the amount of data used for verifying the identity or the authenticity of a speaker of the audio signal. It may be required not to store a significant amount of data in addition to the audio signal, since this may limit the storing options and increase the resources required for processing the audio signal. Some prior art systems that aim at identifying voice conversion have become complex to a degree that it is impractical to store the full system setup in association with a generated short signal, for example a signal shorter than a few minutes.

Yet another technical problem relates to maintaining the privacy of users. If a solution to solving the data amount problem above requires storing a speaker's characteristics in a database and including in the audio a pointer to this information, the size limitation would be overcome. However, this may be considered personal biometric data and thus subject to regulations by various privacy restrictions, e.g., GDPR.

One technical solution comprises embedding characteristics of the actual speaker within an audio file converted to mimic the voice of a target speaker. Prior art solutions encoded the setup parameters of the voice conversion system within the converted speech, and thus provided the changes that need to be applied to the actual speaker to sound like the target speaker. The current disclosure, however, encodes the characteristics of the actual speaker as part of the audio signal converted to sound like the target speaker. The characteristics may be an x-vector or an i-vector describing the actual speaker voice, and may thus have a size of about few Kilo bytes which can be embedded even within a short audio file or stream. The characteristics may be embedded using steganography methods, for example creating an audio watermark. Some known steganography methods can be found in R. D. Shelke and M. U. Nemade, “Audio watermarking techniques for copyright protection: A review,” 2016 International Conference on Global Trends in Signal Processing, Information Computing and Communication (ICGTSPICC), Jalgaon, 2016, pp. 634-640, incorporated herein by reference in its entirety for all purposes. Steganography is aimed at adding a concealed message to data while maintaining the data, unlike cryptography which aims at encrypting the data itself.

Another technical solution comprises identifying the actual speaker from a modified speech. The solution comprises extracting from a modified audio signal the characteristics of the actual speaker embedded therein, retrieving from another source the characteristics of a suspected speaker, and comparing the characteristics of the suspected speaker to the extracted characteristics. If the two characteristic sets are close enough, e.g., the distance therebetween is below a predetermined threshold, the actual speaker may be identified as the suspected speaker, and corresponding handling may be provided, for example taking a preventive action such as notifying a law representative. It will be appreciated that if multiple suspected speakers exist, the characteristics of each suspected speaker may be compared against the extracted characteristics. The suspected speaker whose characteristics are at the lowest distance from the extracted characteristics, provided that the distance is below the threshold, may be identified as the speaker. Such process may be informally regarded as a voice line-up.

Yet another technical solution comprises providing speech signal in the likeness of the original voice from a modified speech signal. The characteristics of the actual speaker may be extracted from the audio signal. Using text to speech techniques, a second audio signal may be synthesized, which uses the characteristics of the actual speaker. The synthesized audio signal may then be presented to a human listener. The listener may identify general attributes (e.g., gender, age, speaking style, or the like) or may identify the original speaker as a known person, which may be helpful in locating suspects. In some embodiments, the audio signal may undergo speech to text, in order to retrieve the spoken text. The same text may then be used for synthesizing the second audio signal, which may make the signal comparison easier.

One technical effect of the disclosure relates to using a descriptor of the actual speaker characteristics which is small enough to be embedded even within a short audio signal.

Another technical effect of the disclosure relates to being able to verify the identity of an actual speaker by comparing the characteristics embedded within the signal to pre-stored characteristics of the alleged actual speaker.

Yet another technical effect of the disclosure relates to being able to authenticate the actual speaker by comparing the audio signal to a second audio signal synthesized in accordance with the characteristics of the actual speaker.

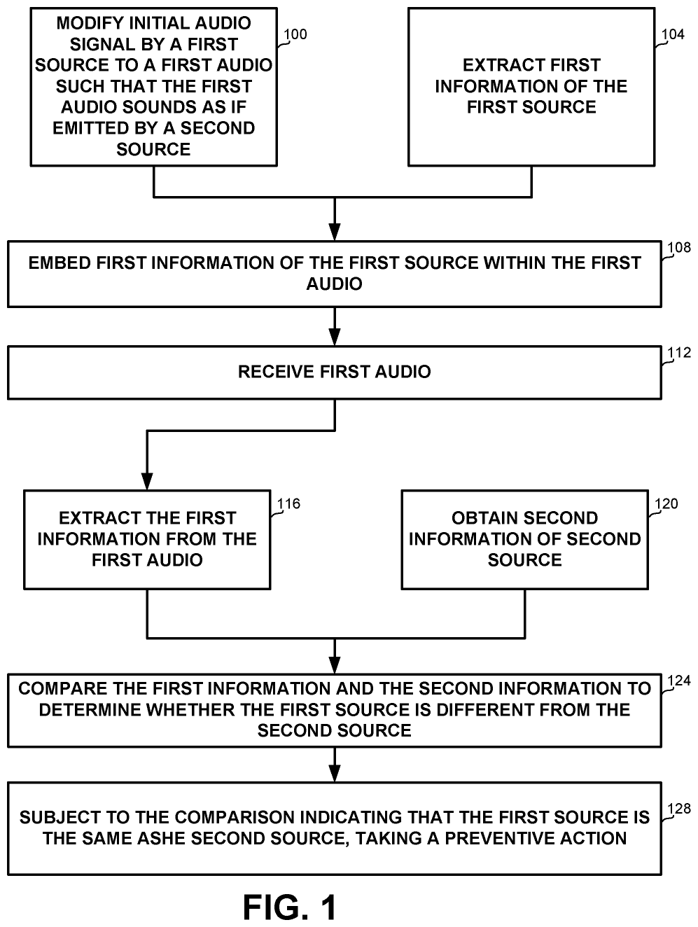

Referring now to FIG. 1, showing a flowchart diagram of a method for verifying the identity of a speaker in a converted audio signal, in accordance with some exemplary embodiments of the disclosed subject matter.

FIG. 1 relates to a method that may be performed when identities of one or more suspected speakers are believed to be known.

On step 100, an initial audio signal comprising speech by a first source, e.g., an actual speaker, may be converted, i.e., modified into a first audio, such that the first audio sounds as if emitted by a second source, e.g. a target speaker. The speech modification can be performed using any known algorithm or method.

On step 104, information indicative of the first source, such as a first speaker, may be extracted from the voice of the first source. The information may include voice characteristics of the first source, and may be arranged in any required format. For example, the information may be represented as a vector in a space referred to as “speakers' space” where audio samples from similar speakers are represented by vectors that are closer to each other than vectors from different speakers. An implementation may use DNN-based approach to extract x-vectors, as described for example in D. Snyder, D. Garcia-Romero, G. Sell, D. Povey, and S. Khudanpur, “X-Vectors: Robust embeddings for speaker recognition”, published in ICASSP, Proc. 2018, incorporated herein by reference in its entirety for all purposes. Another implementation may comprise HMM-GMM mapping process to extract i-vectors as described in Dehak, N. et. al., “Support Vector Machines versus Fast Scoring in the Low-Dimensional Total Variability Space for Speaker Verification” published in Proc Interspeech 2009, Brighton, UK, September 2009, incorporated herein by reference in its entirety for all purposes. However, it will be appreciated that any other compact description of the voice from the actual speaker can be used as well.

On step 108, the first audio may be modified, such that the first information as extracted from the first source may be embedded therein. Embedding may be performed, for example, using a steganography method. However, the modification does not change significantly what the audio signal sounds like, and the voice signal may be used for any voice-relates purpose. For example, the probability that a human or automated process will identify the speaker of the modified audio as the target speaker is similar to the probability of identification before the modification. Steganography may be performed using any required method, such as LSB, frequency modulation, or the like.

On step 112, the first audio as modified may be received by an identification system. The identification system may be different from a voice conversion system used for steps 104 and 108. The first audio may be received online as it is being created, for example modified as the actual speaker speaks and transmitted over a communication channel, retrieved from a storage device, or the like.

On step 116, the first information embedded within the audio signal may be extracted from the first audio. Extraction may exercise the opposite operation to the steganography, i.e., extracting the data embedded within the audio, such as the LSB, the frequency modulation, or the like.

On step 120, second information may be retrieved, for example characteristics such as x-vector or i-vector (in correspondence with the type of the first information) of a third source, being for example a suspected speaker. The characteristics may be retrieved, for example, from another audio signal or from a storage device storing multiple such characteristics.

On step 124, the first information and the second information may be compared. In some embodiments, a metric may be defined for comparing the first information and second information, such as a distance between two x-vectors or two i-vectors. Thus, the comparison may include calculating a distance between two vectors, wherein such calculation may include calculating a sum or a weighted sum of the differences of the corresponding vector elements.

Subject to the comparison results being that the distance between the first information and the second information exceeds a predetermined threshold, it may be determined that the first audio and the second audio cannot be attributed to the same source, i.e. the actual speaker is probably not the suspected speaker. Otherwise, if the distance between the first information and the second information is below a second threshold, which may be lower than the first threshold, it may be determined that the first audio and the second audio can be attributed to the same source, therefore the actual speaker in the initial audio signal is likely to be the suspected speaker.

In some embodiments, for example if the distance is between the first and second thresholds, further checks may be performed in order to verify whether the actual speaker is the same as the suspected speaker.

On step 128, an action may be taken depending on the comparison result. If the first audio and the second audio can be attributed to the same source, a preventive action may be taken, for example notifying a person in charge, notifying a law or regulation enforcement agency, denying access to information or service, storing indications in a stored device, or the like.

The action may be performed by accessing an interface of a system or service for taking the action, for example an Application Program Interface of an application or service that takes the action.

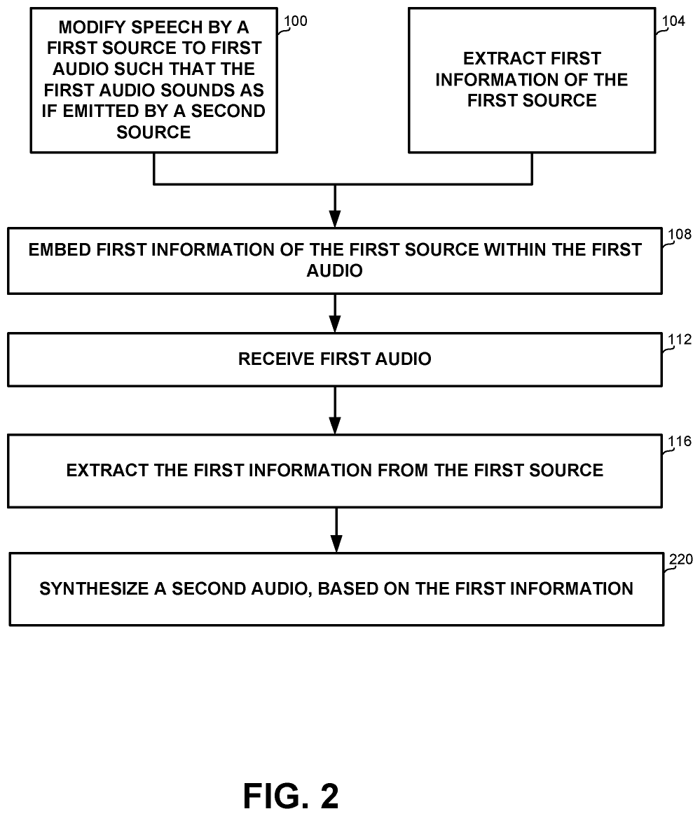

It will be appreciated that the methods described in association with FIG. 1 and FIG. 2 above are applicable to converted signals having been generated as described in steps 100 and 104 above, i.e. signals in which it may be identified that the original voice has been converted.

Referring now to FIG. 2 showing a flowchart diagram of a method for reconstruction of a speaker voice from a modified audio signal, in accordance with some exemplary embodiments of the disclosed subject matter.

Step 100, 104, 108, 112 and 116 are as described in association with FIG. 1 above.

On step 220, a second audio may be synthesized, based on the first information as extracted from the first audio, such as the x-vector or the i-vector embedded within the modified speech. The second audio is thus aimed to reconstruct how the actual source, e.g., the actual speaker of the first audio sounds, since it uses the first information that is extracted from the first source's speech. The second audio may use a text-to-speech engine to generate sound upon predetermined text.

In some embodiments, the first audio may undergo speech recognition, i.e., speech to text, in order to retrieve the text spoken within the first audio. The second audio can then be synthesized using the same text, such that comparing the first audio and the second audio is easier.

The synthesized audio may then be used, for example a user may listen to the synthesized audio and determine whether the voice is familiar

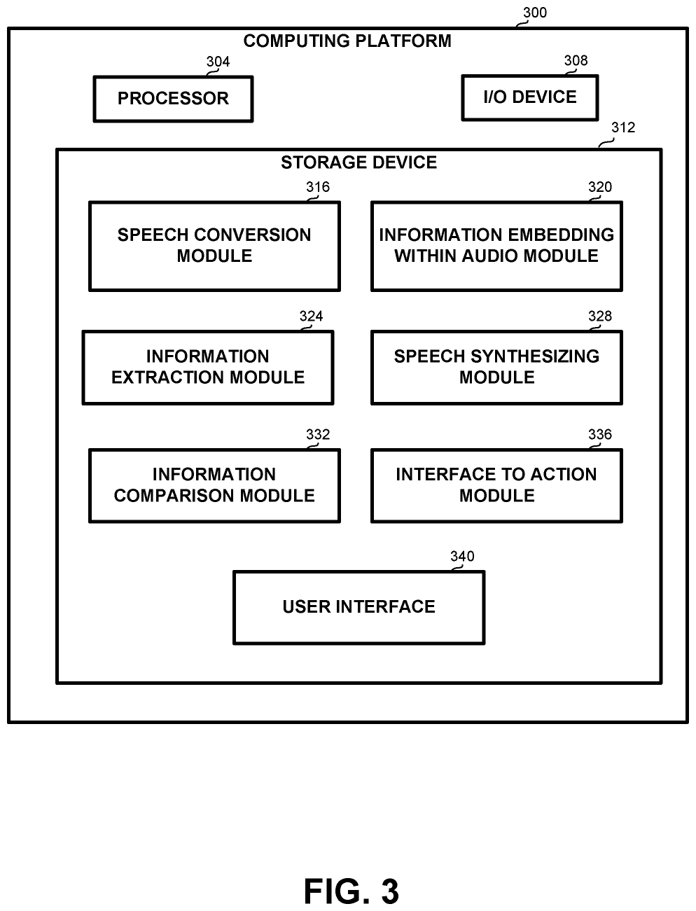

FIG. 3 shows a block diagram of a system configured for identifying a speaker from a modified audio signal.

The system may comprise one or more Computing Platforms 300. In some embodiments, Computing Platform 300 may be a server, and may provide services to one or more clients, such as one or more telephone or Voice over IP channels of an organization or of multiple organizations. In further embodiments, Computing Platform 300 may be the same, or one of the computing platforms executing tasks for a client.

Computing Platform 300 may communicate with other computing platforms via any communication channel, such as a Wide Area Network, a Local Area Network, intranet, Internet or the like.

Computing Platform 300 may comprise a Processor 304 which may be one or more Central Processing Units (CPU), a microprocessor, an electronic circuit, an Integrated Circuit (IC) or the like. Processor 304 may be configured to provide the required functionality, for example by loading to memory and activating the modules stored on Storage Device 312 detailed below.

It will be appreciated that Computing Platform 300 may be implemented as one or more computing platforms which may be operatively connected to each other. For example, some components may be implemented as part of a conversion system, while others may be implemented as part of a system for determining an actual speaker, and yet other components may be implemented as part of a synthesizing system. It will also be appreciated that Processor 304 may be implemented as one or more processors, whether located on the same platform or not.

Computing Platform 300 may comprise Input/Output (I/O) Device 308 such as a display, a speakerphone, a headset, a pointing device, a keyboard, a touch screen, or the like. I/O Device 308 may be utilized to receive input from and provide output to a user, for example play two audio files to the user for the user to decide whether the audio files contain speech by the same speaker.

Computing Platform 300 may comprise a Storage Device 312, such as a hard disk drive, a Flash disk, a Random Access Memory (RAM), a memory chip, or the like. In some exemplary embodiments, Storage Device 312 may retain program code operative to cause Processor 304 to perform acts associated with any of the modules listed below, or steps of the methods of FIG. 1 or FIG. 2 above. The program code may comprise one or more executable units, such as functions, libraries, standalone programs or the like, adapted to execute instructions as detailed below.

Storage Device 312 may comprise Speech Conversion Module 316, for converting an audio signal such that it sounds like another person is speaking, rather than the original speaker. Speech Conversion Module 316 may use any desired voice conversion engine.

Storage Device 312 may comprise Information Embedding within Audio Module 320, for embedding additional information within an audio signal, for example using steganography. The information may include characteristics of the original speaker of the audio signal, and may be an x-vector or an i-vector. Embedding the information within the audio does not significantly change the way the audio sounds to a human or is processed by an automated process.

In some embodiments, Speech Conversion Module 316 and Information Embedding within Audio Module 320 may be implemented as one module. In some embodiments, either Speech Conversion Module 316 or Information Embedding within Audio Module 320 may receive or otherwise obtain the information to be embedded, e.g., the voice characteristics of the original speaker.

Storage Device 312 may comprise Information Extraction Module 324, for extracting the information embedded using steganography within an audio signal, to obtain characteristics of an actual speaker of the audio signal.

Storage Device 312 may comprise Speech Synthesizing Module 328, for receiving text to be spoken, and characteristics of a target voice, and outputting an audio signal in which the text is spoken by a voice that sounds substantially like the target voice.

Storage Device 312 may comprise Information Comparison Module 332 for comparing two vectors characterizing two speakers, and determining a distance between the two vectors. The distance being above a first threshold may indicate that the two vectors represent speech characteristics by different persons, the distance being below a second threshold may indicate that the two vectors represent speech characteristics of two different persons. The distance being between the first threshold and the second threshold may require additional investigation.

Storage Device 312 may comprise Interface to Action Module 336, which may output a signal to one or more systems or components using their corresponding interfaces, for carrying out various actions, such as preventive actions which may be taken if it is determined that a suspected person has converted his or her voice to sound like another person.

Storage Device 312 may comprise User Interface 340, for displaying to a user data or information, playing audio segments, or the like, and receiving instructions or indications from a user, such as whether two audio segments are spoken by the same person.

It will be appreciated that the module description above is exemplary only, that the modules may be arranged differently, and that the division of tasks between the modules may be different.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving a first audio, wherein the first audio is a conversion of an audio by a first source to a second source, wherein the first audio having embedded therein first information characterizing the first source of the audio;
extracting from the first audio the first information of the first source embedded within the first audio;
obtaining second information characterizing a third source;
comparing the first information to the second information to obtain comparison results; and
subject to the comparison results indicating that the first source is the same as the third source, initiating an action.

2. The method of claim 1, wherein the first information or the second information is a vector representing a voice in a speakers' space.

3. The method of claim 2, wherein the first information or the second information is an x-vector or an i-vector.

4. The method of claim 1, wherein the first information is embedded within the first audio using steganography.

5. The method of claim 1, wherein the first information is embedded within the first audio as a watermark.

6. The method of claim 1, further comprising:
modifying speech by the first source such that the first audio sounds as if emitted by the second source;
obtaining the first information characterizing the first source from speech by the first source; and
embedding the first information in the first audio.

7. A method comprising:
receiving a first audio, wherein the first audio is a conversion of an audio by a first source to a second source, wherein the first audio having embedded therein first information characterizing the first source of the audio;
extracting from the first audio the first information of the first source based on the information embedded within the first audio; and
synthesizing, based on the first information, a second audio comprising speech in the likeness of the first source.

8. The method of claim 7, wherein said synthesizing comprising applying text-to-speech to text spoken in the first audio.

9. The method of claim 7, wherein the first information is a vector representing a voice in a speakers' space.

10. The method of claim 9, wherein the first information is an x-vector or an i-vector.

11. The method of claim 7, wherein the first information is embedded within the first audio using steganography.

12. The method of claim 7, wherein the first information is embedded within the first audio as a watermark.

13. The method of claim 7, further comprising:
modifying speech by the first source such that the first audio sounds as if emitted by the second source;
extracting information of the first source from speech by the first source; and
embedding the information of the first source within the first audio.

14. A computer program product comprising a non-transitory computer readable medium retaining program instructions, which instructions when read by a processor, cause the processor to perform:
receiving a first audio, wherein the first audio is a conversion of an audio by a first source to a second source, wherein the first audio having embedded therein first information characterizing the first source of the audio
extracting from the first audio the first information of the first source embedded within the first audio;
obtaining second information characterizing a third source;
comparing the first information to the second information to obtain comparison results; and
subject to the comparison results indicating that the first source is the same as the third source, initiating an action.

15. The computer program product of claim 14, wherein the first information or the second information is an x-vector or an i-vector representing a voice in a speakers' space.

16. The computer program product of claim 14, wherein the processor is further configured to perform:
modifying speech by the first source such that the first audio sounds as if emitted by the second source;
obtaining the first information characterizing the first source from speech by the first source; and
embedding the first information in the first audio.

17. The computer program product of claim 14, wherein the processor is further configured to perform:
receiving a first audio, wherein the first audio is a conversion of an audio by a first source to a second source, wherein the first audio having embedded therein first information characterizing the first source of the audio;
extracting from the first audio the first information of the first source based on the information embedded within the first audio; and
synthesizing, based on the first information, a second audio comprising speech in the likeness of the first source.

18. The computer program product of claim 17, wherein said synthesizing comprises applying text-to-speech to text spoken in the first audio.

19. The computer program product of claim 14, wherein the first information is embedded within the first audio using steganography.

20. A system comprising a unit retaining the non-transitory computer readable medium of claim 14 and the processor.
